(19) United States
(12) Patent Application Publication
(10) Pub. No.: US 2005/0081758 A1
(43) Pub. Date: Apr. 21, 2005

(54) Adjunct for improving the bioenergetic properties of mineral building materials

(75) Inventors: Karl Grieder, Runenberg (CH); Gideon Cajus Flachsman-Fontalba, Le Mont-Pelerin (CH)

Correspondence Address: NORRIS, MCLAUGHLIN & MARCUS, 875 THIRD AVE, 18TH FLOOR, NEW YORK, NY, 10022, US

(73) Assignee: Labor Grieder, Runenberg (CH)

(21) Appl. No.: 10/510,914

(22) PCT Filed: Apr. 9, 2003
(86) PCT No.: PCT/IB03/01415

(30) Foreign Application Priority Data
Apr. 15, 2002 (EP) 02076429.6

(51) Int. Cl. C04B 14/48; C04B 16/00; C04B 22/04; C04B 14/00; C04B 24/00; C04B 40/00

(52) U.S. Cl. 106/819; 420/475; 106/640; 106/731; 106/814

(57) ABSTRACT

The invention relates to a metal mixture, which, in addition to a support material such as wood charcoal as an adjunct to inorganic or organic materials, improves the bioenergetic properties thereof. Said adjuncts improve the biologically-relevant construction properties, in particular the bioenergetic influence of cement-containing mineral building materials such as concrete, mortar, plaster and coatings. The above finds application in all cement-containing mineral building materials and comprises one or several metals in elementary powder form and optionally a support material. The above preferably comprises the metals zinc, copper, lead, tin, antimony, silver and gold in varying amounts and wood charcoal as support material. The wood charcoal component also has the effect of a pigment and in high concentrations leads to a light concrete with improved thermal insulation properties.

The invention relates to a mixture of metals in the elementary form, which, as an additive to inorganic and organic materials improves their bio-energetic properties. The metal mixture is preferably applied together with a support material such as wood charcoal.

In particular, the invention concerns the application of this metal mixture together with a support material such as wood charcoal as an additive for cement containing mineral building materials for the improvement of their biologically-relevant building properties.

By “mineral building materials” preparations are meant which contain as substantial components mineral binders such as lime and/or especially cement as well as aggregates: sands, gravels, broken stones or other fillings of natural or synthetic origin. As a rule, the mineral building materials are prepared by mixing the mineral binder like cement and aggregates together with water into a ready-to-use preparation which can harden in the open air as well as under water.

These important mineral building materials are often felt to be problematic in residential building construction regarding cosiness and well-being. For instance, it is recommended in the patent DE 19623693 to the investors to examine generally the wholesomeness of the provided building materials and to avoid the problematic ones.

With regard to this, in the present invention there will be described an additive which harmonises the bio-energetic properties of cement-containing mineral building materials and therefore improves the climate of the living space.

The additive must be homogeneously distributed in the building materials. To attain an optimal intermixture, preferably the additive is mixed homogeneously with the cement and then combined with the aggregates.

By “biologically-relevant building properties” of the mineral construction materials mainly the bio-energetic effect on living organisms are meant. This influence on people and animals can be proved in concrete buildings, cement mortars and cement-containing plasters and coatings, but also is influencing development of plants in the relevant environment (hothouses or plant containers).

General bio-sensitive testing methods, by preference electro-acupuncture, can be used to examine the bio-energetic effect of the mineral building materials. These testing methods are described in the literature (for example, in Introduction to the Electro-acupuncture after Voll by Friedrich J. Begher, Uelzen medical-literary publishing house, 1994 ISBN 3-88136-162-6) and are acknowledged as important criteria by the experts. With the help of electro-acupuncture procedures after Voll (EAV) the possible influence of construction materials on the human organ and energy systems can be determined.

By this biometrical method the conductivity of tissues in the acupuncture points of the examined person is measured. The measurement gives information about the functional state of the corresponding organ and energy systems. With the help of a so called “outside testing container”, the strain on organ and energy systems caused by building materials can be directly measured.

The patent DE 2840114 describes a method for testing biologically effective electro-magnetic radiations of inorganic and organic substances as well as their complex combinations concerning their toxic and non-toxic quantity and quality, their influence on biological systems such as minerals, plants, animals and people, as well as other elements and their combinations.

By a comparative test of the influence of concrete with and without the described inventive additive, the influence on human meridians, respectively on the relevant organ or energy system can be proved. It shows that the conventional concrete can arouse a predisposition to variable imbalances, i.e. imbalances of the circulation, heart, lungs or colon systems. These imbalances, however, disappear in the case of concrete with the described inventive additive.

The influence of the additive on plants growth or on cut flowers durability can directly be observed when vessels of concrete with and without the described additive are used.

The additives of the present invention are metals in an elementary powdered form chosen from the group consisting of iron, zinc, copper, lead, tin, antimony, mercury, silver and gold, and preferably is a mixture of metals, thoroughly pulverised and homogenised, preferably in particles of <0.1 mm size, optionally together with a support material, preferably wood charcoal with suitable particle size (i.e. <0.1 mm).

This additive must be mixed with cement or mineral building material in concentrations of approximately 0.01-20% by weight, based on the amount of cement. It must be taken into consideration that the metals of the described additive could be found as trace elements in the concrete. Through the cement production process they are, however, oxidized and do not have the described effect anymore.

A preferred additive contains metals in portions of 0.001 to 15% and the support material in portions of 85 to 99.999%. The preferred metals are zinc, copper, lead, tin, antimony, silver and gold, preferably all in different quantities.

It is well known that the use of wood charcoal as addition to mineral building materials influences their technical behaviour. So, building materials can be obtained with improved thermal insulation properties or with reduced specific gravity or wood charcoal can serve as colouring pigment.

These familiar effects are likewise achieved with the metal mixture according to the invention when wood charcoal is used as support material, attaining in addition an improvement of the bio-energetic properties of the building materials.

### EXAMPLES

### Example 1

### Additive with 2 Components

| Components | Portion | Material |
|---|---|---|
| B | 25.0 g | Copper |
| H | 475.0 g | Wood charcoal |
| Total | 500.00 g | Additive |

For the production of the additive, the mixture is grinded and homogenized to a particle size of <0.05 mm.

### Example 2

### Additive with 8 Components

| Components | Portion | Material |
|---|---|---|
| A | 32.500 g | Zinc |
| B | 25.000 g | Copper |
| C | 8.000 g | Lead |
| D | 1.250 g | Tin |
| E | 0.150 g | Antimony |
| F | 0.040 g | Silver |
| G | 0.003 g | Gold |
| H | 433.057 g | Wood charcoal |
| Total | 500.000 g | Additive |

For the production of the additive, the mixture is grinded and homogenized to a particle size of <0.05 mm.

### Example 3

### Concrete Composition

a) Conventional

b) with additive

| Components | a) conventional | b) with additive |
|---|---|---|
| Quartz sand 1.5-3.0 mm | 1485 g | 1460 g |
| Gravel 3-8 mm | 3765 g | 3765 g |
| Gravel 8-16 mm | 3330 g | 3330 g |
| Total Aggregates | 8580 g | 8555 g |
| Additive as in Example 1 or 2 | | 25 g |
| Portland cement NORMO 4, | 2475 g | 2475 g |
| CEM I 42.5 | | |
| Drinking water | 1238 g | 1238 g |
| Total | 12 293 g | 12 293 g |
| | W/C = 0.50 | W/C = 0.50 |

### Example 4

### Preparation of Concrete

Equipment

Multi flow-mixing device type SE/GB (electro-engine), mixing container (h=20.7 cm, d=40.6 cm)

Experimental

a) Concrete Without Additive (Conventional)

2475 g of Portland cement are put in the mixing container of the multi flow-mixing device. Then the whole aggregate quantity (8580 g) is added and is mixed dry for 1 minute. Thereafter, within 30 seconds two thirds of the calculated water quantity are added under continuous mixing. Within the next 30 seconds, the other one third of water is added to the mixture. Then the concrete is mixed for 3 minutes more. The production of the concrete mixture is finished within 5 minutes altogether.

b) Concrete with Additive (Invention)

25 g of additive are mixed dry with 2475 g of Portland cement in the mixing container of the multi flow-mixing device. Then, the whole quantity (8555 g) of aggregate are added and mixed again dry for 1 minute. Thereafter, two thirds of the calculated water quantity are added within 30 seconds under continuous mixing. Within the next 30 seconds, the other one third of water is added to the mixture. Then the concrete is mixed for 3 minutes more. The production of the concrete mixture is finished within 6 minutes altogether.

From the mixtures a) and b) cubes with edge length of 10 cm are produced for testing.

### Bio-Energetic Test

Method:

The bio-energetic testing of the cube with conventional concrete and concrete with additive (according to the invention) is performed according to the electro-acupuncture method after Voll (EAV) under application of “outside testing container”. Correct application of the method must be assumed (see Introduction to the electro-acupuncture after Voll (EAV), by Friedrich J. Begher, Uelzen publishing house, 1994).

The EAV-Method is based on the measurement of the conductivity of the tissues at the acupuncture points on the tested person. The measurement gives information about the functional state of the corresponding organ and energy system. With the help of the “outside testing container”, the strain on the organ and energy system caused by building materials on the tested person can be directly measured.

Measuring Principle:

The measuring principle consists in generating a small current (about 10 microamperes) by putting a small net voltage (up to 1 Volt) between a negative hand-electrode and a positive point-electrode. Usually on neutral skin, a current of less than 1 microampere is measured, but on electrically different points a current of 4-100 microamperes is measured.

Analysis of the Measured Values:

(after Pitterling H., Naturheilpraxis 10/99, p. 1538-1540, Pflaum publishing house, Munich)

| Instrument scale | Diagnostic interpretation |
|---|---|
| 10-20 | Total degeneration |
| 20-30 | Advanced degeneration |
| 30-40 | Advancing degeneration |
| 40-50 | Beginning degeneration |
| 50 | Normal value (ideal) |
| 50-65 | Tolerance area for normal value |
| 65-80 | Irritation |
| 80-90 | Partial inflammation |
| 90-100 | Total inflammation |

The Needle Drop (ND):

If in spite of a constant electrode imprint and an exactly searched acupuncture point, a needle drop (ND) occurs from a former highest value to a lower terminal value, this phenomenon is regarded as the most important criterion for diagnosis and therapy. The difference between the highest value and the drop indicates the degree of the functional and organ imbalance.

Experimental Arrangement for Testing the Bio-Energetic Influence of Concrete:

In the following described results, the negative hand-electrode is held in the left hand and the EAV-values are determined on the right hand at measuring points 1-10. The measurement is repeated after 1 minute. The result of the second measurement shows the basic value. (Tables 1-3, column “basic value”). After 1 minute the “outside testing container” is put on the cube of concrete conventional from Example 4 and the EAV-values are measured at points 1-10 on the right hand (Tables 1-3, column “concrete conventional”). After 1 minute the “outside testing container” is put on the cube of concrete with additive (invention) from Example 4 and the EAV-values are measured at points 1-10 on the right hand (Tables 1-3, column “concrete with additive”). The duration of one measuring series is about 20 minutes.

Tables 1-3: Typical Test Results With EAV Measurement

TABLE 1
Test person: ♂ 57 years old

| | Strain on organ and energy system | | | | |
|---|---|---|---|---|---|
| | | Difference to the basis value | | | |
| | | a) concrete | | b) concrete | |
| | Basic value | conventional | | with additive | |
| Quadrants | Gauge | no | | no | |
| Test points | graduated | influ- | difference | influ- | difference |
| Right hand | from 0-100 | ence¹ | >10% | ence¹ | >10% |
| Lymphe meridian | 49 | √ | | √ | |
| Lungs meridian | 53 | | −7 | √ | |
| Colon meridian | 56 | √ | | √ | |
| Nerves meridian | 56 | √ | | √ | |
| Circulation meridian | 49 | | ND 44/38 | √ | |
| Allergy meridian | 51 | √ | | √ | |
| Organ degeneration | 49 | | ND 48/34 | √ | |
| Endocrine meridian | 54 | | +6 | √ | |
| Heart meridian | 48 | | ND 52/44 | √ | |
| Small intestine | 52 | √ | | √ | |
| meridian | | | | | |

TABLE 2
Test person: ♂ 72 years old

| | Strain on organ and energy system | | | | |
|---|---|---|---|---|---|
| | | Difference to the basis value | | | |
| | | a) concrete | | b) concrete | |
| | Basic value | conventional | | with additive | |
| Quadrants | Gauge | no | | no | |
| Test points | graduated | influ- | difference | influ- | difference |
| Right hand | from 0-100 | ence¹ | >10% | ence¹ | >10% |
| Lymph meridian | 47 | √ | | √ | |
| Lungs meridian | 44 | √ | | √ | |
| Colon meridian | 46 | √ | | √ | |
| Nerves meridian | 47 | √ | | √ | |
| Circulation meridian | 49 | √ | | √ | |
| Allergy meridian | 54 | √ | | √ | |
| Organ degeneration | 48 | √ | | √ | |
| Endocrine meridian | 48 | √ | | √ | |
| Heart meridian | 44 | | +6 | √ | |
| Small intestine | 50 | | +12 | √ | |
| meridian | | | | | |

TABLE 3
Test person: ♀ 3½ years old

| | Strain on organ and energy system | | | | |
|---|---|---|---|---|---|
| | | Difference to the basis value | | | |
| | | a) concrete | | b) concrete | |
| | Basic value | conventional | | with additive | |
| Quadrants | Gauge | no | | no | |
| Test points | graduated | influ- | difference | influ- | difference |
| Right hand | from 0-100 | ence¹ | >10% | ence¹ | >10% |
| Lymph meridian | 62 | √ | | √ | |
| Lungs meridian | 58 | √ | | √ | |
| Colon meridian | 50 | | −6 | √ | |
| Nerves meridian | 42 | | +7 | √ | |
| Circulation meridian | 51 | √ | | √ | |
| Allergy meridian | 50 | √ | | √ | |
| Organ degeneration | 52 | √ | | √ | |
| Endocrine meridian | 50 | √ | | √ | |
| Heart meridian | 51 | √ | | √ | |
| Small intestine | 55 | √ | | √ | |
| meridian | | | | | |

Experimental arrangement: The “outside testing container” was uncoupled to ascertain the basis value. To determine the strain by conventional concrete, respectively by concrete with additive, the “outside testing container” was put on the relevant cube of concrete.
¹no influence: Difference to the basic value <10%
ND: Needle Drop with highest and terminal values

1-13. (canceled)

14. An additive for inorganic and organic building materials comprising copper or a mixture of copper with one or more metals from the group consisting of iron, zinc, lead, tin, antimony, silver and gold in elementary and powdered form in portions of each 0.01 to 20 percent by weight and optionally a support material.

15. An additive for cement-containing building materials comprising copper or a mixture of copper with one or more metals from the group consisting of iron, zinc, lead, tin, antimony, silver and gold in elementary and powdered form in portions of each 0.01 to 20 percent by weight and optionally a support material.

16. An additive according to claim 14 in which the metals have a particle size of <0.1 mm.

17. An additive according to claim 14 comprising wood charcoal as support material.

18. An additive according to claim 14 comprising the metals in portions of 0.001 to 15% and the support material in portions of 85 to 99.999%.

19. An additive according to claim 14 comprising the metals zinc, copper, lead, tin, antimony, silver and gold in different amounts.

20. In a process for the production of a cement-containing mineral building material with improved bio-energetic properties, the improvement comprising the incorporation of an additive according to claim 14.

21. In a process according to claim 20, the improvement that the additive is used in quantities from 0.01% to 20% by weight of the cement quantity.

22. In a process for the production of a cement-containing mineral building material with improved thermal insulation properties and with improved bio-energetic properties, the improvement comprising the incorporation of an additive according to claim 14.

23. In a process for the production of a cement-containing mineral building material with reduced specific gravity (wood charcoal-light concrete) and with improved bio-energetic properties, the improvement comprising the incorporation of an additive according to claim 17.

24. In a process for the production of a colored cement-containing mineral building material with improved bio-energetic properties, the improvement comprising the incorporation of an additive according to claim 17.

25. Cement-containing mineral building materials with improved bio-energetic properties comprising an additive according to claim 14.

26. (canceled)

27. Additive for cement-containing mineral building materials, characterised in that it contains copper or a mixture of copper with one or more metals in elementary and powdered form in portions of each 0.01 to 20 percent by weight and optionally a support material.
